(19) United States
(12) Patent Application Publication
(10) Pub. No.: US 2014/0289046 A1
(43) Pub. Date: Sep. 25, 2014

(54) Mobile Sales Targeting Application

(71) Applicant: Kalyan Bukkapatnam, Dallas, TX (US)

(72) Inventor: Kalyan Bukkapatnam, Dallas, TX (US)

(21) Appl. No.: 14/219,305

(22) Filed: Mar. 19, 2014

Related U.S. Application Data
(60) Provisional application No. 61/803,286, filed on Mar. 19, 2013.

(51) Int. Cl. G06Q 30/02

(52) U.S. Cl. CPC G06Q 30/0267; G06Q 30/0259
USPC 705/14.57

(57) ABSTRACT

The disclosed system relates to the pairing of retailers and customers by way of a mobile application.

### CROSS-REFERENCE TO RELATED APPLICATION(S)

This application claims priority from U.S. Provisional Application No. 61/803,286, filed Mar. 19, 2013, and entitled “Mobile Sales Targeting Application” which is hereby incorporated herein by reference in its entirety.

### FIELD OF THE INVENTION

The disclosure relates to devices, systems and methods for promoting sales. More specifically, the present application relates to applications for mobile devices, such as cellular phones.

### BACKGROUND OF THE INVENTION

The disclosed system relates to applications for use on cellular telephones and other devices. More specifically, the disclosed system relates to methods, systems, and computer-readable media comprising applications for sing messages to mobile devices based on the location of the mobile devices and targeting users based on parameters associated with said users of the mobile devices.

The development of the internet, social media and smart mobile devices has resulted in drastic increases in the amount of information available to a consumer at any time. These mobile devices have become a platform for delivering a nearly less variety of information to the consumer, wherever the consumer carries the device. The information can be customized to the consumer's particular preferences. It is known in the art that advertisements and coupons can be sent directly to a mobile device to be readily available to the consumer, via email, text message, push notifications or by other means.

It is also known that the use of an individual user's exact location can be used to target them for specific nearby vendors. However, in the art these kinds of micro-targeted advertising are typically one-way communications, in which vendors are able to send offers and ads to users based upon their exact location and users simply whether or not to purchase them. However, the individual users have heretofore not had a role in driving the exact goods or services being offered, nor had the ability to interact either directly or indirectly with the vendors.

Thus, there is a need in the art for a software application that brings together the concepts of micro-targeted advertising with the ability to consumer or user communication with vendors so as to enhance the efficacy of the advertisements and offers as well as promote an active conversation about prices between and amongst users and vendors.

### BRIEF SUMMARY OF THE INVENTION

Discussed herein are various embodiments of the disclosed system that serve the following as well as other objectives that will be appreciated by those skilled in the art.

In Example 1, certain embodiments of the disclosed system utilize factors such as the user's location, local altitude, local weather, time of day, age, ethnicity, prior purchasing activity, prior posting activity and other factors to establish appropriate offers or advertisements.

Example 2 relates to the exemplary embodiment according to Example 1, wherein the business location, local altitude, weather, time of day, and business goods or services are utilized to select certain goods or services to offer to the user.

Example 3 relates to the exemplary embodiment according to Example 2, wherein the business provides an offer to the user based on the available factors.

Example 4 relates to the exemplary embodiment according to Example 3, wherein the user's prior social postings about an individual product or service influence the selection of the offer made to the user.

Example 5 relates to the direct interaction between the user and vendor, either by direct or indirect means to establish an offer.

While multiple embodiments are disclosed, still other embodiments of the disclosed system will become apparent to those skilled in the art from the following detailed description, which shows and describes illustrative embodiments of the invention. As will be realized, the invention is capable of modifications in various obvious aspects, all without departing from the spirit and scope of the disclosed system. Accordingly, the drawings and detailed description are to be regarded as illustrative in nature and not restrictive.

### BRIEF DESCRIPTION OF THE DRAWINGS

The features and advantages of the invention are explained in more detail in the subsequent detailed description with reference to the embodiments illustrated in the attached drawing figures, in which like reference numerals denote like elements and in which FIGS. 1-5F illustrate certain exemplary embodiments of the disclosed system.

FIG. 1A is a flow chart showing an overview of the features contained in certain embodiments of the disclosed system.

FIG. 1B is a flow chart showing an overview of the features contained in certain embodiments of the disclosed system.

FIG. 1C is a flow chart showing an overview of the features contained in certain embodiments of the disclosed system.

FIG. 2A is a screenshot showing certain aspects of the disclosed system contained in exemplary embodiments.

FIG. 2B is a screenshot showing certain aspects of the disclosed system contained in exemplary embodiments.

FIG. 3A is a screenshot showing certain aspects of the disclosed system contained in exemplary embodiments.

FIG. 3B is a screenshot showing certain aspects of the disclosed system contained in exemplary embodiments.

FIG. 3C is a screenshot showing certain aspects of the disclosed system contained in exemplary embodiments.

FIG. 3D is a screenshot showing certain aspects of the disclosed system contained in exemplary embodiments.

FIG. 3E is a screenshot showing certain aspects of the disclosed system contained in exemplary embodiments.

FIG. 3F is a screenshot showing certain aspects of the disclosed system contained in exemplary embodiments.

FIG. 4A is a screenshot showing certain aspects of the disclosed system contained in exemplary embodiments.

FIG. 4B is a screenshot showing certain aspects of the disclosed system contained in exemplary embodiments.

FIG. 4C is a screenshot showing certain aspects of the disclosed system contained in exemplary embodiments.

FIG. 5A is a screenshot showing certain aspects of the disclosed system contained in exemplary embodiments.

FIG. 5B is a screenshot showing certain aspects of the disclosed system contained in exemplary embodiments.

FIG. 5C is a screenshot showing certain aspects of the disclosed system contained in exemplary embodiments.

FIG. 5D is a screenshot showing certain aspects of the disclosed system contained in exemplary embodiments.

FIG. 5E is a screenshot showing certain aspects of the disclosed system contained in exemplary embodiments.

FIG. 5F is a screenshot showing certain aspects of the disclosed system contained in exemplary embodiments.

FIG. 6A is a screenshot showing certain aspects of the disclosed system contained in exemplary embodiments.

FIG. 6B is a screenshot showing certain aspects of the disclosed system contained in exemplary embodiments.

FIG. 6C is a screenshot showing certain aspects of the disclosed system contained in exemplary embodiments.

FIG. 7 is a screenshot showing certain aspects of the disclosed system contained in exemplary embodiments.

FIG. 8A is a screenshot showing certain aspects of the disclosed system contained in exemplary embodiments.

FIG. 8B is a screenshot showing certain aspects of the disclosed system contained in exemplary embodiments.

FIG. 8C is a screenshot showing certain aspects of the disclosed system contained in exemplary embodiments.

FIG. 9 is a screenshot showing certain aspects of the disclosed system contained in exemplary embodiments.

### DETAILED DESCRIPTION

The various systems and methods disclosed herein relate to applications and methods for use on computing devices. More specifically, various embodiments relate to applications and methods for use on computers, tablets, mobile phones and other devices (“mobile devices”). It is understood that the various embodiments disclosed herein can be incorporated into or used with any other known applications and methods or the various associated mobile devices. It is understood that the various mobile device, system and method embodiments disclosed herein, including that which is shown in the Figures, can be used in a variety of combinations, and that the various embodiments described herein are not limited.

The disclosed system consists of a application for such mobile devices. More specifically, in certain exemplary embodiments, the disclosed system generally consists of a platform for pairing users with nearby vendors, and allowing users and vendors to interact as a means of maximizing commerce. By way of example, exemplary embodiments of the disclosed system evaluate the parameters and conditions unique to a user's specific location and is capable of receiving personalized offers for the user from nearby vendors. In further examples, the user's prior use of the application are used to influence and drive the interaction between vendors and users. In further examples, the characteristics of an individual user's activity with the application are used to further drive the interaction between the vendors and users.

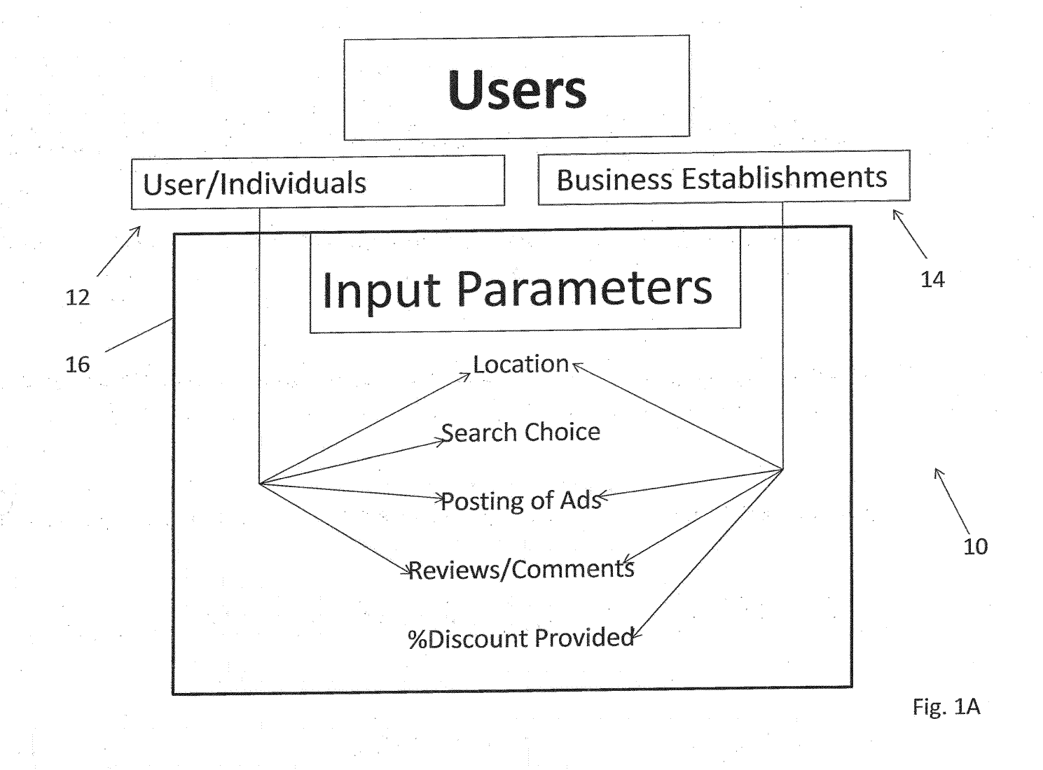

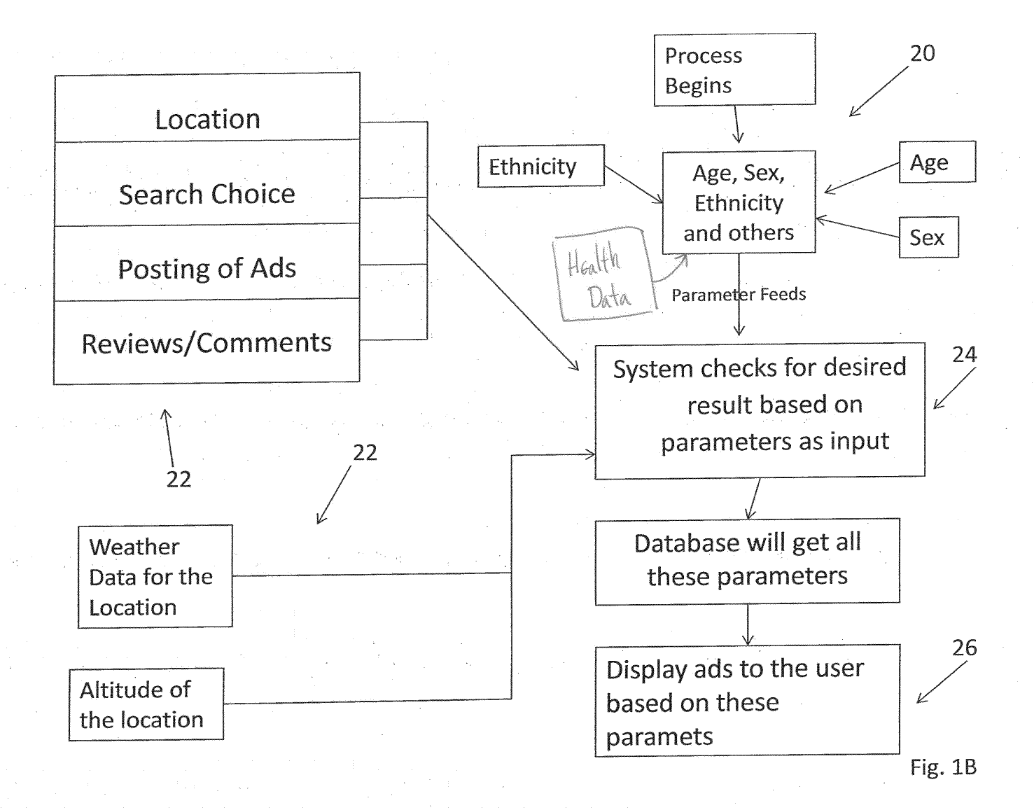

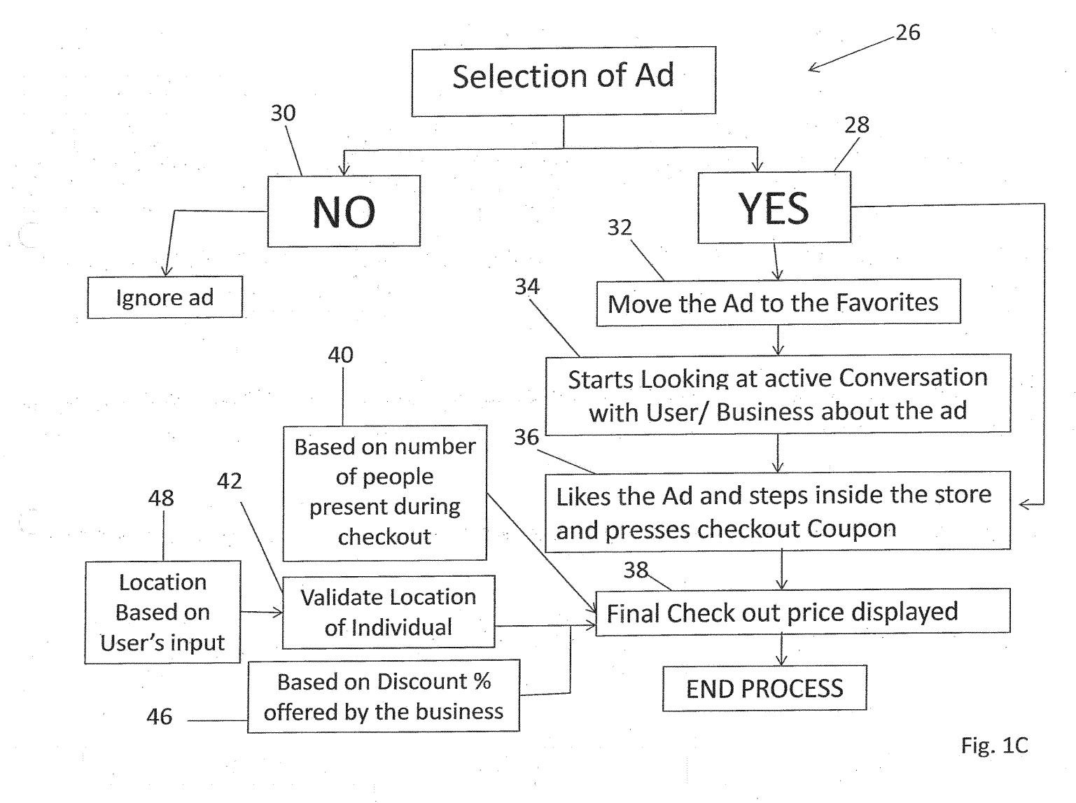

An overview of some exemplary systems herein contained is shown in FIG. 1. In these implementations, users and retailers are paired based upon a variety of input parameters. Thus, as is shown generally in FIGS. 1A-1C, certain embodiments of the disclosed system allow the application to assess the user's location, including such factors as the altitude and weather conditions (i.e. temperature), and certain known preference factors of the user. Using these factors, various nearby vendors are able to specifically target users with discounted offerings on specific goods or services. Because user preferences for products can change drastically based upon certain environmental and other conditions, the disclosed system thereby allows vendors to provide highly desirable deals to users, and users are positioned to receive low cost, nearby access to goods and or services that they may desire. As used herein, and for clarity, the term “application” shall refer to the various embodiments of the disclosed system.

By way of example, FIG. 1A-1C shows an overview some exemplary embodiments and key features of the disclosed system. As shown generally in FIG. 1A-1C, the disclosed system 10 allows users 12 and vendors 14 to specify certain input parameters, shown generally at 16. In certain exemplary embodiments, users and vendors can view or post locations, search terms, advertisements, reviews and comments, and particular discounts that allow the conveyance of information between users and vendors.

As depicted in FIGS. 1B-1C, the disclosed system assembles information about the user and the vendor. As shown generally at 20, in certain exemplary embodiments, various demographic information about the user is utilized to best inform the dialogue between the users and vendors. For example, such traits as the age, sex, and ethnicity of the user can help to inform specific vendors of goods or services that may appeal to the user, so as to allow further targeting and specialization of the services offered. Additional user traits that can be used relate to user health data. For example, information related to using body temperature, blood pressure, blood glucose may be used to target products that are relevant to that information. Further, various local geographic, atmospheric, seasonal and other conditions can also be incorporated so as to enhance the targeting of the user by the local business. Weather data, altitude, location, season and the like can all be used in any combination, or combined with the demographic information that is provided by the user to better inform businesses of the kinds of offers that they wish to provide to the users. This information is gathered and processed by a central server, or other database 24, so as to match users and retailers and provide targeted advertisements 26 to the user. By way of example, in a certain embodiment, on a late December day in a cold-weather region, a local coffee house may provide a particular kind of drink at a discount, for example an eggnog latte, which can be provided to particular users of the application by way of a targeted message or offer. As such, certain implementations can allow such targeted promotion to local users based upon a variety of factors.

In certain exemplary embodiments, the disclosed system is able to assemble all of the specified information about the user and vendor as a means for providing the user with a specially targeted offer, shown generally at 26 in FIG. 1C. The user then has the ability to select the offer 28, or ignore it 30. If the user ignores it, the process s.

If the user accepts the ad, a variety of processes may occur. The ad may be moved to the favorites 32, as described in detail below. The selection of the ad can also begin the initiation of a conversation 34 between the user and the retailer, also as described below. In other embodiments, the user can accept the ad 36 and elect to purchase the good or service offered 38. Based on how the ad is received by targeted users, the retailer performs a number of subsequent processes, including offering further increasing discounts, based either on achieving a certain number of sales 40, or in response to the actions of a rival business, or other promotional means that would be clear to one of skill in the art, generally at 46. The disclosed system can also validate the location of the individual 42 compared to the location given by the user 48.

Another principle aspect of the disclosed system is that in certain embodiments, the disclosed system can facilitate a dialogue or conversation between the user and vendors, so as to microtarget advertisements, promotions, or the like to specific users based on a variety of input parameters, as discussed in reference to FIG. 1A above. In these embodiments, this conversation or dialogue involves the selective targeting of vendors or users by the other based upon the specific parameters and interacting through the various means discussed in reference to FIG. 1C. By way of example, and as shown generally in FIGS. 2-6, the user is able to post information about a product or service to the application as a means of conversing with other users and vendors themselves.

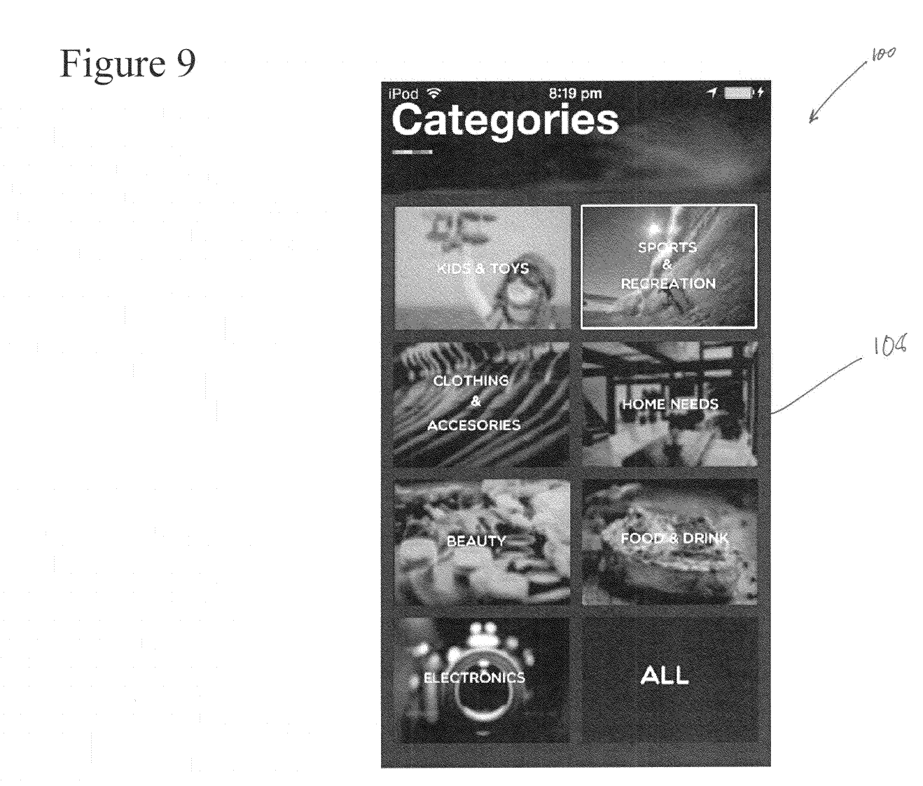

As an example, FIGS. 2A-2B show a series of screen shots of exemplary embodiments of the disclosed system. Other embodiments are possible, as would be apparent to one of skill in the art. FIG. 2A shows a basic home screen 100 for the disclosed system including a close button 102, a camera or picture view 104, and a camera button 106. FIG. 2B shows a category selection menu 108 and a back button 110 according to an exemplary embodiment of the system. An alternate embodiment is shown in FIG. 9. The category selection menu 108 is used to quickly navigate the user to the desired category of goods or services that the user wishes to direct the user's activity toward.

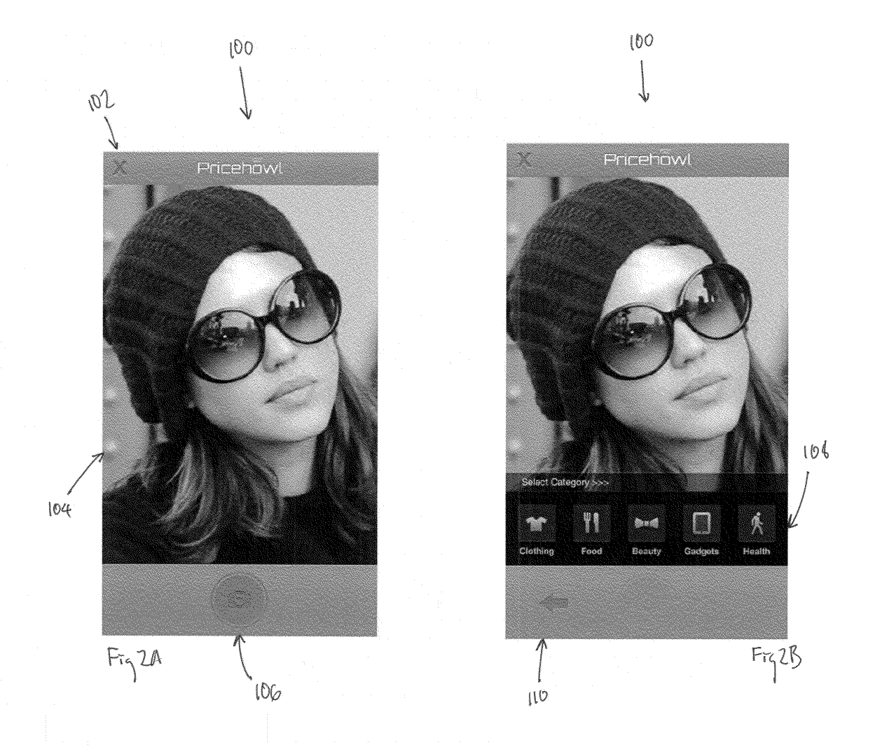

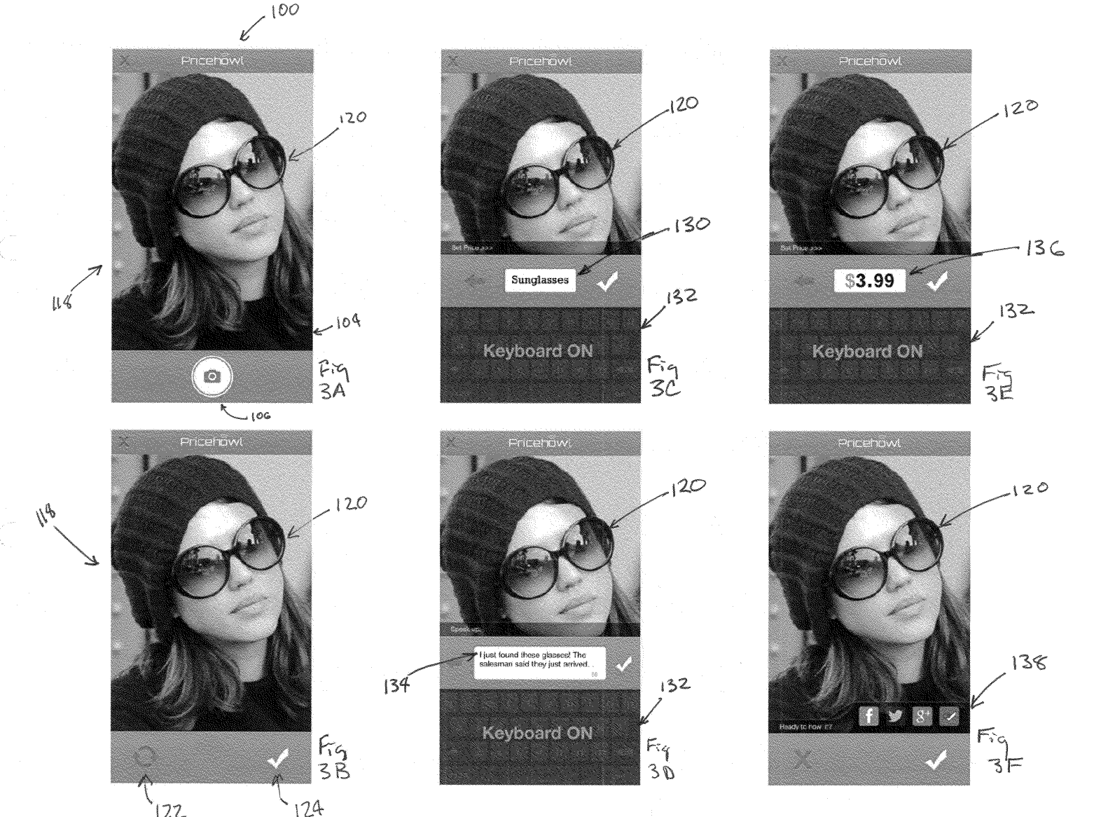

FIGS. 3A-3F show additional features of certain exemplary embodiments of the disclosed system. One key aspect of the disclosed system is the ability for a user to tag and price products and services of interest. As shown in FIG. 3A, in exemplary embodiments of the disclosed system the user is able to use the application 100 to take photographs 118 of goods or services (or “product,” designated by 120) which are in turn displayed on the camera or picture view 104. Here, by way of example, the product is designated by the sunglasses shown at 120. As would be apparent, any other product could be used and remain within the scope of the disclosed system, as is shown in FIG. 6A-C in relation to consumer electronics 220 and flowers 222. The user is able to take a photograph 118 of the product 120 using, for example, a camera button 106. Other means of product input, such as bar codes, QR codes, SKU numbers and the like are also possible. As shown in FIG. 3B, in certain embodiments of the disclosed system after taking the photograph or scan 118 of the product 120, the user can be presented with a choice to keep 124 or reject 122 the current photograph or scan 118.

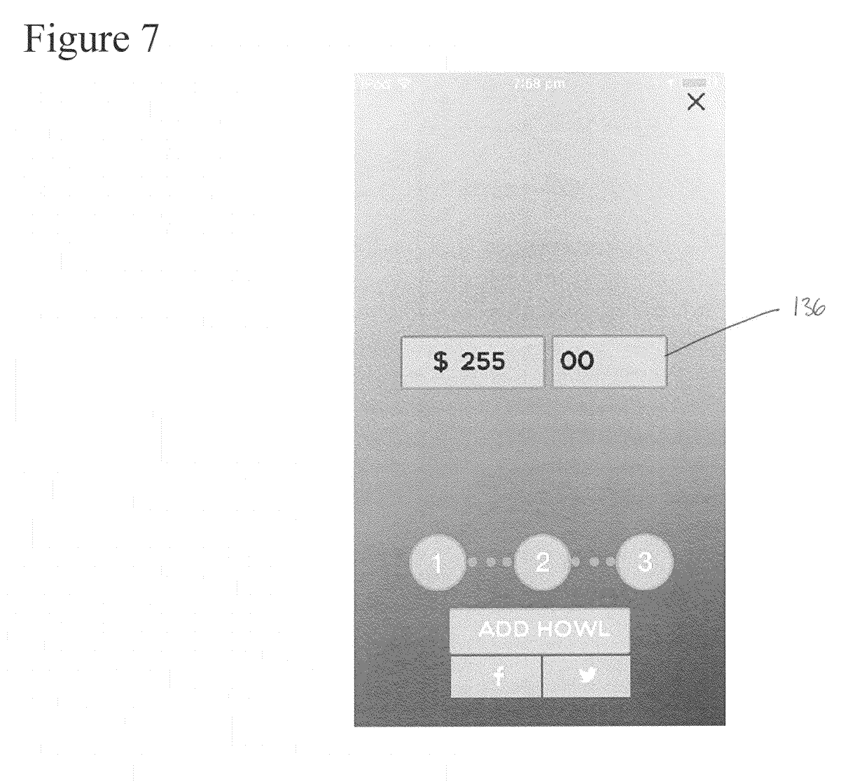

Another aspect of certain embodiments of the disclosed system is the ability to share information and opinion about the item 120, as is illustrated in FIGS. 3C-3E. In FIG. 3C, and according to certain embodiments of the disclosed system, the user is able to “tag” 130 the product 120 with a description or other information. In certain embodiments, this can be done by way of a pop-up keyboard 132, though other methods, such as voice commands, can be employed. In certain embodiments, and as best shown by FIG. 3D, the user has the option to provide further comment 134 on the product 120. These embodiments allow the user to comment or give opinion or other feedback about the product, and thus contributes to the dialogue between the user and vendor. Yet another key aspect of certain embodiments of the disclosed system, and as best shown in FIG. 3E, the user is given the option of transmitting the price 136 of the product 120, again by entry into a specific box provided by the application for that purpose (an alternative embodiment of which is shown in FIG. 7).

It is thus a principle aspect of exemplary embodiments of the disclosed system is the integration with other social media sites. By way of example, Facebook, Twitter, Pinterest, Yelp, Google Plus, Four Square and other social media sites can be integrated with the disclosed system so as to allow the user to post directly to other social media sites about individual products or services. For example, and as shown in FIGS. 2A-2F, if a user encounters a product, the user may upload identifying information about that product 120, and the user has the ability to then transmit this information and comment by way of the disclosed system itself as well as associated social media sites which have been paired to certain embodiments of the application, in some embodiments by way of a button or button provided on the touch screen 138.

Thus, in certain embodiments, the disclosed system allows users to interact either directly or indirectly with vendors by way of social media so as to provide vendors with information about the user's thoughts on the products or services and encourage the vendor to provide the user with certain offers (as described earlier), as well as provide the user with specialized or personalized customer service. Because vendors are able to receive such real-time information about a customer's product preferences, demographic information, and other information, they are able to tailor their offers to that customer and thereby have the “conversation” with the users. Users are also able to comment on a vendor's services, offers, and general alacrity by way of the present application, thus informing other users as to the overall quality of service provided by vendors, thus providing an incentive to the vendors to both participate and provide good service.

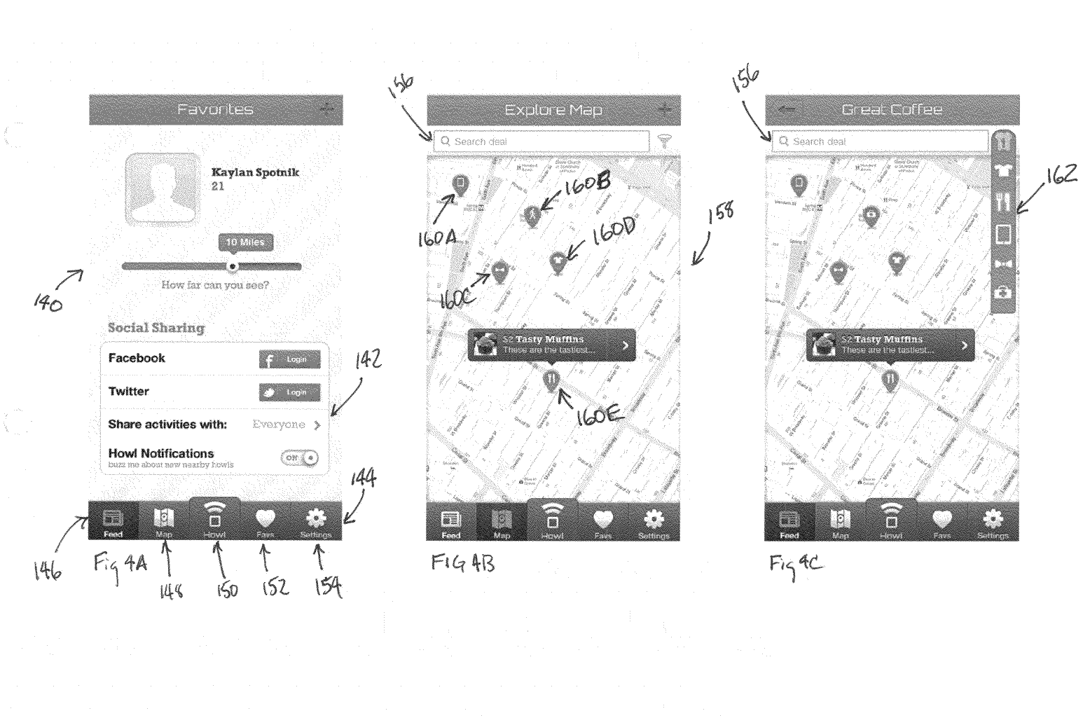

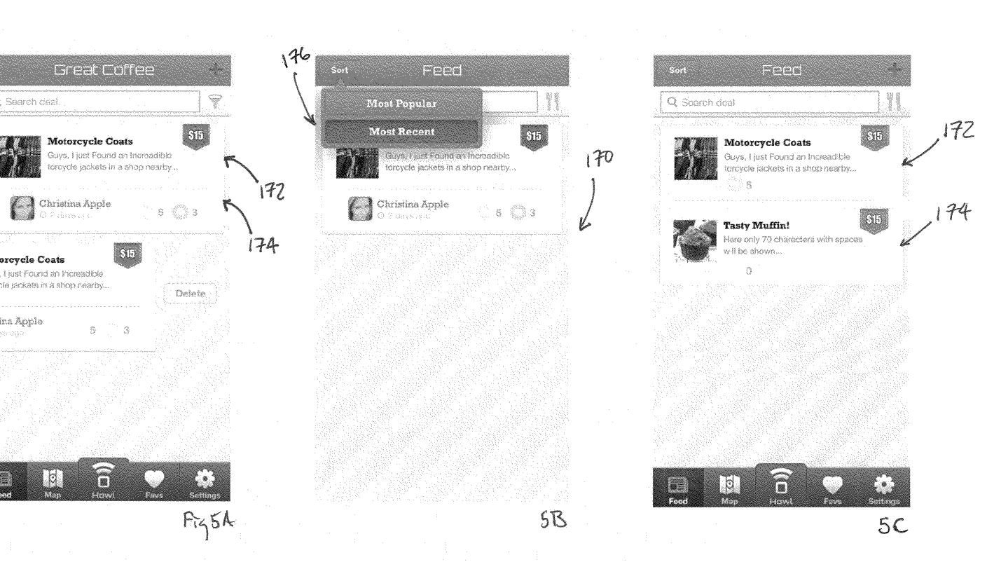

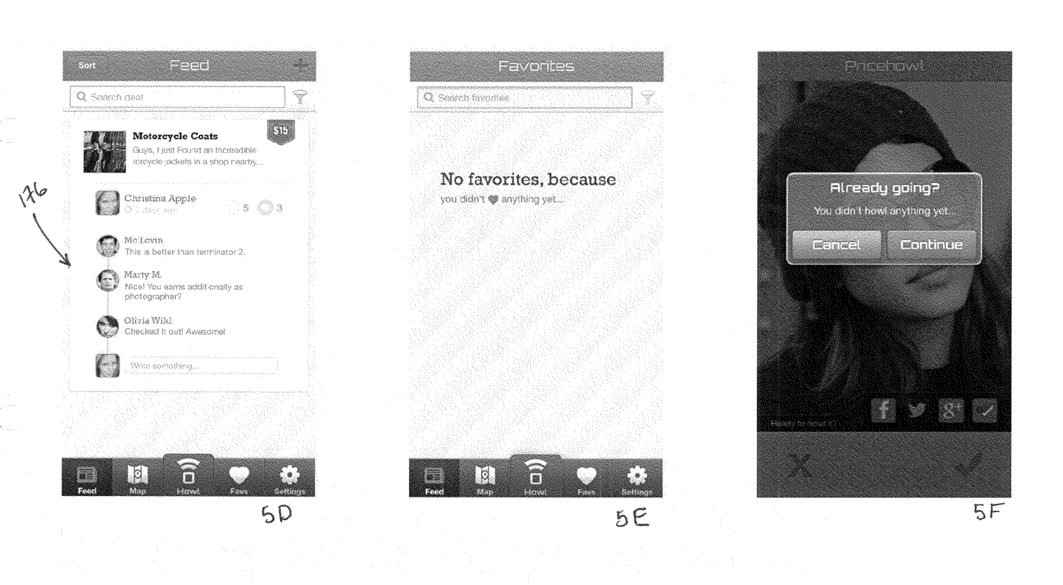

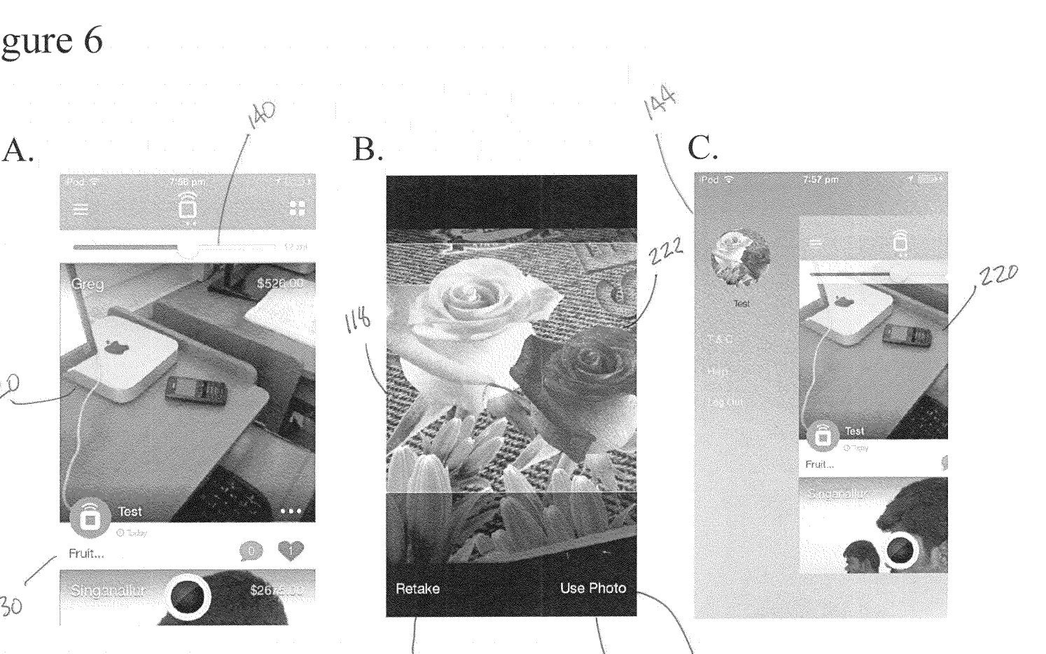

As shown in FIGS. 4A-4C, another key feature of exemplary embodiments of the disclosed system is the ability for users to easily perform searches. These Figures show an overview of some of the search features that may be present in certain embodiments of the disclosed system which provide true “driver friendly” functionality. For example, in certain embodiments, and as best shown in FIG. 4A, the disclosed system can possess a range slider 140, so as to easily allow the user to customize the range of businesses which are proximate given the user's particular situation. Many prior art applications involve preset ranges, such as 1, 5, 10 miles and so on, but those ranges don't most accurately reflect the individual nature of certain environments. In the disclosed system, the range can be set to any distance the user prefers by the use of the slider 140. Further, and as mentioned elsewhere herein, certain embodiments of the disclosed system provide the user with the ability to link with other social media sites by way of a login box 142. Certain embodiments allow the user to tailor their receiving audience and provide other user-specific customization. In certain embodiments of the disclosed system, a touch button menu 144 can be provided to allow the user to easily navigate between the particular features of the disclosed system. In the example shown in FIG. 4A, the present application offers a Feed 146, which gives the user access to other user's tags/comments/prices as well as vendor offers that may be directly pushed to the user's device; a map 148; the “Howl” function 150, which will allow the user to transmit their information to other users, as is described in reference to FIGS. 3A-3F and 5A-5D; a “Favorites” 152 link that allows the user to store information about their favorite vendors as is described in reference to FIG. 5E and as is well known in the art; and Settings 154, which are also well known in the art.

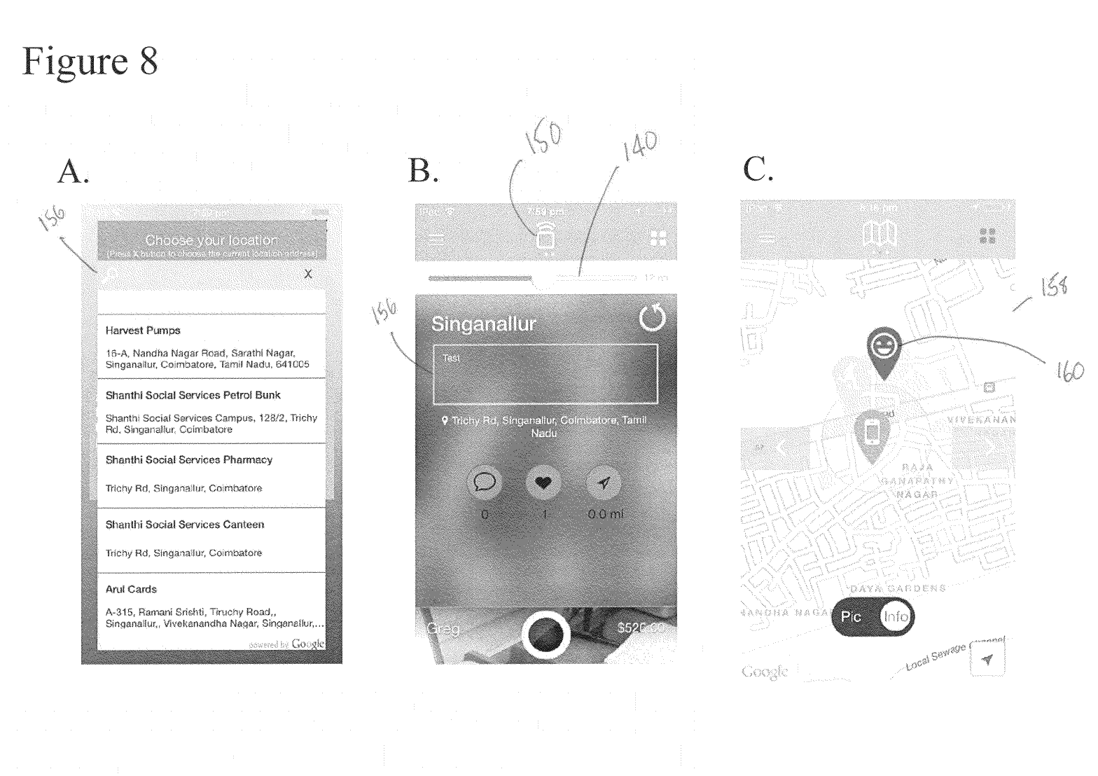

As shown in FIG. 4B and FIG. 8, in certain embodiments, the disclosed system allows the user to search a map for certain kinds of vendors. In exemplary embodiments, this occurs within the range specified by the user, as explained in relation to FIG. 4A. In certain embodiments, this is performed by way of a search box 156, though other means well known in the art are clearly also possible, as would be obvious to one of skill in the art. Following a search, in certain embodiments a map view 158 of the results 160A-E is displayed for the user. A list or other view is also within the scope of the present embodiment. The user may then select a specific result 160E to receive more information about the vendor as well as personalized offers.

One key aspect of certain embodiments of the disclosed system is that rather than requiring a user to enter a specific search term, such as “Restaurant,” into the search box 156, these embodiments feature a drop-down sidebar 162 with button functionality, such that an icon for “Restaurant” may be available. In the example shown in FIG. 4C, five such icons are shown, representing Restaurants/Food, Gadgets, Clothes, Home Needs and Beauty, with “Restaurant/Food” having been selected. In practice, the user is then able to simply press that button and receive offers for products in their specific area based upon that simple selection. These buttons allow the user to quickly and easily select the category of vendor that is desired at any given time without having to use text or speech inputs.

One key aspect of exemplary embodiments of the disclosed system is the ability to communicate information about products, offers and vendors to other users, as is shown generally as 170 in FIGS. 5A-5D. This feed allows the user to see posts by vendors and users 172, 174, including offers, comments and the like, as shown throughout FIGS. 5A-5D. In certain exemplary embodiments, the user is able to use a sorting function 176 to sort the content, for instance by popularity or time. FIG. 5E shows a screenshot for the favorite page, as can be used in certain exemplary embodiments. FIG. 5F shows an exemplary sign-off page 180, as used in certain exemplary embodiments.

While multiple embodiments are disclosed, still other embodiments of the disclosed system will become apparent to those skilled in the art from the following detailed description, which shows and describes illustrative embodiments of the invention. As will be realized, the invention is capable of modifications in various obvious aspects, all without departing from the spirit and scope of the disclosed system. Accordingly, the drawings and detailed description are to be regarded as illustrative in nature and not restrictive.

Although the disclosed system has been described with reference to preferred embodiments, persons skilled in the art will recognize that changes may be made in form and detail without departing from the spirit and scope of the invention.

1-3. (canceled)

4. A method for targeting advertisements to a mobile device user, comprising:
a) receiving from a vendor one or more target-user characteristics defining an offer criteria;
b) receiving from a user of a mobile device one or more user characteristics;
c) cross referencing the one or more user characteristics with the target-user characteristics of the offer criteria; and
d) delivering an offer to the mobile device when the one or more user characteristics match the offer criteria.

5. The method of claim 4, wherein user characteristics are selected from a group consisting of user demographics, location, altitude, purchase history, product search history, keyword search, known preferences, desired deal proximity, and health information.

6. The method of claim 5, wherein user demographics further comprise user age, gender, race, ethnicity, employment status, education level, income, mobility, familial status, and household size.

7. The method of claim 4, wherein user characteristics further comprise the environmental conditions in the user's location.

8. The method of claim 5, wherein health information further comprises the user's blood glucose level.

9. The method of claim 4, further comprising providing a user input module, for input of user characteristics.

10. The method of claim 9, wherein the user input module provides an offer radius selection tool.

11. The method of claim 9, wherein the user input module provides a product input tool.

12. The method of claim 4, further comprising providing an offer communication module to facilitate communications between the vendor and the user.

13. The method of claim 4, further comprising providing a social media module allowing the user to communicate about the offer via social media.

14. A system for targeting advertisements to a mobile device user, comprising:
a) a target characteristic input module, for inputting one or more target characteristic;
b) a user characteristic input module, for inputting one or more user characteristic;
c) a computer, receiving input from the target characteristic input module and the user characteristic input module, for cross referencing target user characteristics and user characteristics;
d) an offer delivery module, delivering an offer to a mobile device when one or more target user characteristics match one or more user characteristic.

15. The system of claim 14, wherein user characteristics are selected from a group consisting of user demographics, location, altitude, purchase history, product search history, keyword search, known preferences, desired deal proximity, and health information.

16. The system of claim 15, wherein user demographics further comprise user age, gender, race, ethnicity, employment status, education level, income, mobility, familial status, and household size.

17. The system of claim 15, wherein health information further comprises the user's blood glucose level.

18. The system of claim 14, wherein the user input module provides an offer radius selection tool.

19. The system of claim 14, wherein the user input module provides a product input tool.

20. The system of claim 14, further comprising an offer communication module to facilitate communications between the vendor and the user.

21. The system of claim 14, further comprising providing a social media module allowing the user to communicate about the offer via social media.

22. A method for targeting health related advertisements to a mobile device user, comprising:
a) receiving from a vendor one or more target-user health characteristics defining an offer criteria;
b) receiving from a user of a mobile device one or more user health characteristics;
c) cross referencing the one or more user health characteristics with the target-user health characteristics of the offer criteria; and
d) delivering an offer to the mobile device when the one or more user health characteristics match the one or more target-user health characteristic of the offer criteria.

23. The method of claim 22 wherein the user health characteristic is the user's blood glucose level.
